(19) United States
(12) Patent Application Publication
(10) Pub. No.: US 2022/0383631 A1
(43) Pub. Date: Dec. 1, 2022

(54) OBJECT RECOGNITION SYSTEM AND OBJECT RECOGNITION METHOD

(71) Applicant: Hitachi, Ltd., Tokyo (JP)

(72) Inventors: Takashi KANEMARU, Tokyo (JP); Charles Lima SANCHES, Tokyo (JP)

(21) Appl. No.: 17/695,016

(22) Filed: Mar. 15, 2022

(30) Foreign Application Priority Data
May 25, 2021 (JP) 2021-087636

(51) Int. Cl. G06V 10/98; G06V 10/74; G06V 10/77

(52) U.S. Cl. CPC G06V 10/98; G06V 10/761; G06V 10/7715; G06V 10/56

(57) ABSTRACT

An object recognition system is provided to improve recognition accuracy while reducing time and cost for teacher data collection. An essential feature extraction portion extracts, from target image data based on image data acquired by a predetermined camera, a feature related to an element independent of a capture condition of the camera as an essential feature among multiple features respectively related to multiple elements related to a subject appearing in the target image data. A database comparison portion compares the essential feature to a registration feature that is an essential feature extracted from reference image data based on image data acquired by a separate camera from the predetermined camera to identify a subject based on the comparison result.

### CROSS-REFERENCE TO RELATED APPLICATION

The present application claims priority from Japanese application JP 2021-087636, filed on May 25, 2021, the contents of which is hereby incorporated by reference into this application.

### BACKGROUND

The present disclosure relates to an object recognition system and an object recognition method.

Recognition targets such as suspicious objects or suspicious persons are identified by monitoring videos acquired by surveillance cameras to secure public spaces. In the past, videos acquired by surveillance cameras are visually monitored by observers. There is a problem that the number of videos that can be monitored at once is limited. In contrast, in recent years, attention is being paid to the object recognition technology using, e.g., a machine learning technique to automatically recognize desired recognition targets from videos.

With the object recognition technology using machine learning, it becomes possible to accurately recognize a recognition target by generating a learned model trained using large amounts of image data in which a recognition target appears as teacher data (training data) for each already installed surveillance camera. However, when a learned model generated using image data acquired by a specific surveillance camera as teacher data is applied to image data acquired by a separate camera such as a newly installed surveillance camera, an incorrect recognition result may be acquired.

For addressing the above disadvantage, it is contemplated that large amounts of image data acquired by the separate surveillance camera are collected as teacher data to retrain the learned model based on the image data. However, with this method, there is a problem about increased time and cost for collection of teacher data.

U.S. Unexamined Patent Application Publication No. 2019/0065853 discloses an object recognition system capable of reducing the time and cost for collection of teacher data. This object recognition system recognizes vehicles to monitor a vehicle occupying a parking space. To appropriately identify vehicles even when the viewpoint of a surveillance camera changes with respect to the vehicles, domain adaptation is made to adjust a distribution of features between image data acquired by surveillance cameras having different viewpoints. Thus, it becomes unnecessary to collect large amounts of image data acquired from different viewpoints as teacher data. The time and cost for collection of teacher data become reduceable.

### SUMMARY

However, in domain adaptation, correction of a distribution of features of images is mainly focused to avoid a learned model from depending on, e.g., camera viewpoints. Therefore, learning of small differences in recognition targets is not secured. In a task to recognize various bags of individuals, e.g., at a baggage receipt location in an airport, sufficient recognition accuracy may not be secured.

A goal of the present disclosure is to provide an object recognition system and an object recognition method that enable improvement of recognition accuracy while reducing the time and cost for collection of teacher data.

An object recognition system according to one aspect of the present disclosure is an object recognition system that identifies a subject appearing in target image data based on image data acquired by a predetermined capture device. The system includes: an extraction portion that extracts, from the target image data, a feature related to an element independent of a capture condition of the above capture device as an essential feature among multiple features respectively related to multiple elements related to a subject appearing in the target image data; and a comparison portion that compares the essential feature to a registration feature that is the essential feature extracted from reference image data based on image data acquired by a separate capture device from the above capture device to identify the subject based on the comparison result.

According to the present invention, it becomes possible to reduce the time and cost for collection of teacher data and improve the recognition accuracy.

### BRIEF DESCRIPTION OF THE DRAWINGS

FIG. 1 illustrates a functional configuration of an object recognition system of one embodiment of the present disclosure;

FIG. 2 illustrates an example of a hardware configuration of the object recognition system of one embodiment of the present disclosure;

FIG. 3 illustrates an example of an operational environment to operate the object recognition system of one embodiment of the present disclosure;

FIG. 4 is a flowchart for explaining an example of recognition processing;

FIG. 5 explains an example of processing of a domain common element;

FIG. 6 explains an example of a learning method of a domain adaptation network;

FIG. 7 explains an example of processing of an essential feature;

FIG. 8 illustrates an example of a disentanglement network;

FIG. 9 illustrates a display example of a detection result on a display device;

FIG. 10 illustrates another display example of the detection result on the display device; and

FIG. 11 is a flowchart for explaining building processing that builds a database.

### DETAILED DESCRIPTION

Hereinafter, embodiments of the present disclosure are explained in reference to the drawings.

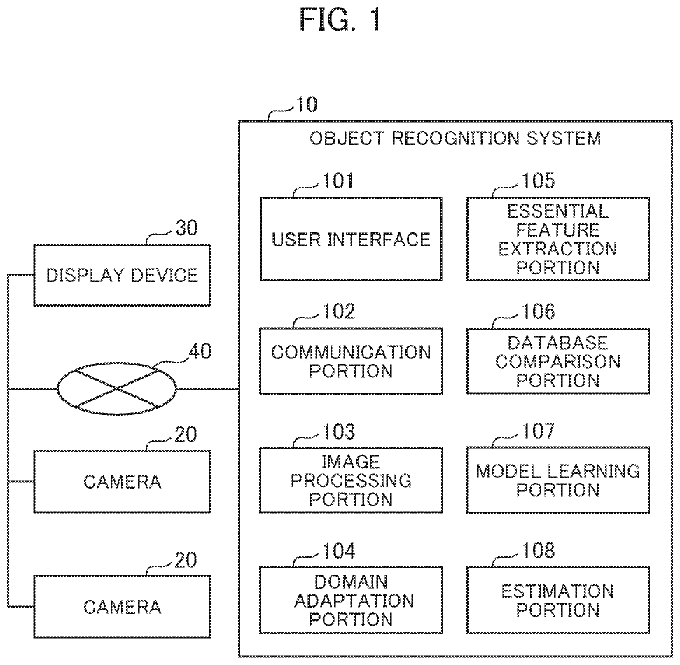

FIG. 1 illustrates a functional configuration of an object recognition system of one embodiment of the present disclosure. An object recognition system 10 is mutually communicatively connected to cameras 20 that are capture devices to acquire image data and to a display device 30 that displays various information via a network 40. An example of FIG. 1 illustrates two cameras 20 and one display device 30. The number of the cameras 20 and display device 30 is not limited to this example. Moreover, the object recognition system 10, cameras 20, and display device 30 may be connected to each other via a wire or wirelessly.

As illustrated in FIG. 1, the object recognition system 10 has a user interface 101, a communication portion 102, an image processing portion 103, a domain adaptation portion 104, an essential feature extraction portion 105, a database comparison portion 106, a model learning portion 107, and an estimation portion 108.

The user interface 101 has a function to receive various information from a user and a function to output various information to the user.

The communication portion 102 communicates with external devices such as the cameras 20 and display device 30 via the network 40. For example, the communication portion 102 receives image data from the cameras 20 or transmits display information to the display device 30.

The image processing portion 103 performs various image processes to image data received by the communication portion 102. For example, the image processing portion 103 performs extraction processing to extract, from image data, partial image data indicating an area in which a predetermined subject appears. Moreover, the image processing portion 103 may perform highlight processing to image data to highlight a specific subject.

The domain adaptation portion 104 inputs target image data to a domain adaptation network to perform domain adaptation. The domain adaptation network is trained based on image data acquired by the respective multiple cameras 20 having different capture conditions (angle of view, background, etc.). The domain adaptation extracts domain common elements of the target image data. The target image data is image data including a subject to be identified. The target image data is data based on image data acquired by any of the cameras 20. In the present embodiment, the target image data is partial image data extracted from image data by the image processing portion 103 in the extraction processing. Moreover, the domain common element is a common feature in target image data under the capture conditions of the respective cameras 20. The feature is, for example, vector information.

The essential feature extraction portion 105 is an extraction portion that extracts, from target image data as an essential feature, a feature related to an element independent of the capture condition of the camera 20 that acquires the target image data as an essential feature among multiple features related to respective multiple elements related to a recognition target that is a subject appearing in the target image data. The essential feature is, e.g., vector information.

The database comparison portion 106 compares a database about domain common elements and essential features to the domain common element extracted by the domain adaptation portion 104 and the essential feature extracted by the essential feature extraction portion 105. Based on the comparison result, the database comparison portion 106 identifies a recognition target appearing in the target image data.

The model learning portion 107 uses image data in which a predetermined target appears as teacher data to generate an object recognition model that learns a function to estimate whether a predetermined subject appears in the image data.

The estimation portion 108 uses the object recognition model generated at the model learning portion 107 to estimate whether the predetermined target appears in predetermined input image data.

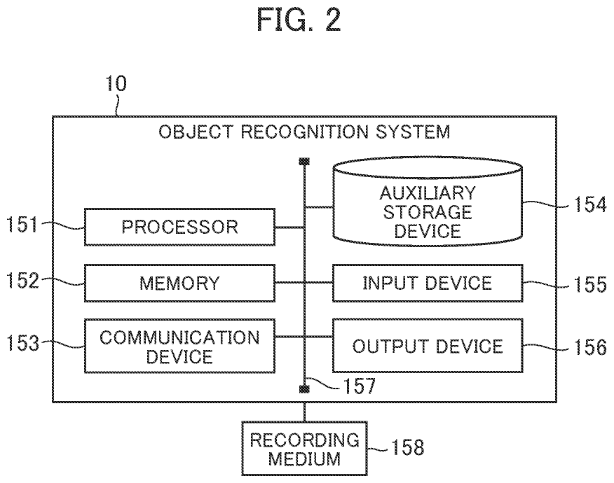

FIG. 2 illustrates an example of a hardware configuration of the object recognition system 10. As illustrated in FIG. 2, the object recognition system 10 includes a processor 151, a memory 152, a communication device 153, an auxiliary storage device 154, an input device 155, and an output device 156. Each hardware device 151 to 156 is communicatively connected to one another via a system bus 157.

The processor 151 reads a computer program and executes the read computer program to realize each functional portion 101 to 108 illustrated in FIG. 1. The memory 152 stores computer programs performed in the processor 151 and various data used in the processor 151. The communication device 153 communicates with external devices such as the cameras 20 and the display device 30 illustrated in FIG. 1. The auxiliary storage device 154 is, e.g., an HDD (Hard Disk Drive), an SSD (Solid State Drive), or a flash memory to permanently store various data. The above database is stored to, e.g., the auxiliary storage device 154. The input device 155 is, e.g., a keyboard, a mouse, or a touch panel to receive manipulations from the user. The output device 156 is, e.g., a monitor or a printer to output various data to the user.

It is noted that the computer programs executed in the processor 151 may be recorded to a non-transitory recording medium 158 readable by a computer. The type of the recording medium 158 is not limited, and includes a flexible disk, a CD-ROM, a DVD-ROM, a hard disk, an SSD, an optical disk, a magneto-optical disk, a CD-R, a magnetic tape, or a nonvolatile memory card. Moreover, at least part of the functions realized in the computer programs may be realized in hardware, e.g., by designing an integrated circuit.

Moreover, the present system may be a physical computer system (one or more physical computers) or a system built on a group of calculation resources (multiple calculation resources) such as a cloud infrastructure. The computer system or the calculation resource group includes one or more interface devices (including a communication device and an input output device), one or more storage devices (including a memory (main storage) and an auxiliary storage device), and one or more processors.

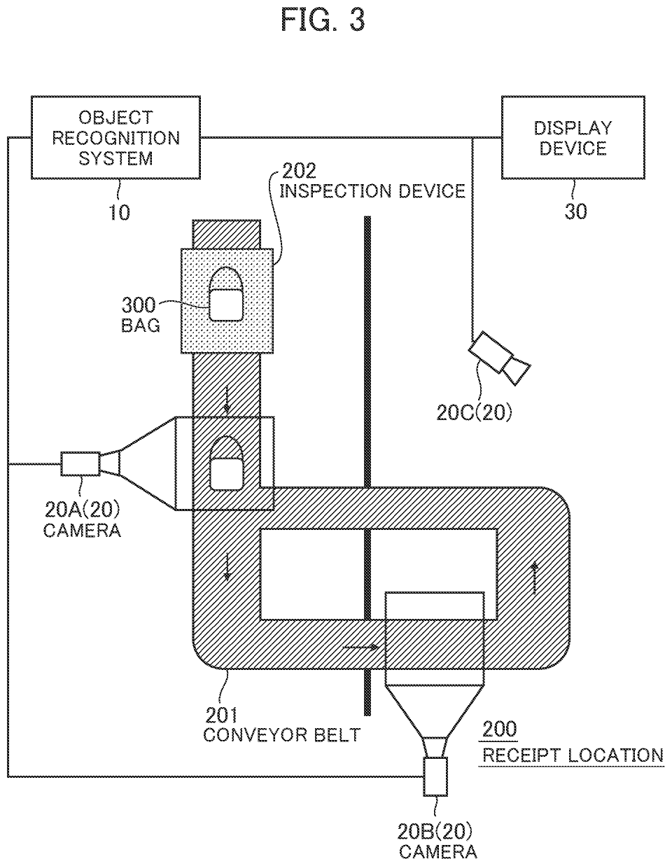

FIG. 3 illustrates an example of operational environment for operation of the object recognition system 10. FIG. 3 illustrates an example in which the object recognition system 10 is operated at a baggage receipt location in an airport.

At a baggage receipt location 200 in an airport, to deliver a bag 300 to the owner, a conveyor belt 201 is provided to carry the bag 300 from the backyard. The bag 300 is baggage carried by an airplane. Moreover, in the middle of the conveyor belt 201, an inspection device 202 is provided to inspect the content of the bag 300. The inspection device 202 is, e.g., an X-ray inspection device to acquire fluoroscopic image data in which the content of the bag 300 appears without opening the bag 300.

The object recognition system 10 and the display device 30 are installed to, e.g., the management department of an airport. Moreover, the cameras 20 are installed to the baggage receipt location 200 etc. to make the bag 300 appear in the image data. In the example of FIG. 3, cameras 20A to 20C are installed as the cameras 20. The cameras 20A and 20B are installed to be able to capture the bag 300 on the conveyor belt 201. The camera 20C is installed to be able to capture the bag 300 received by the owner. For example, the camera 20C is installed to capture the appearance of the receipt of the bag 300 by the owner around the conveyor belt 201 or to capture the entirety of the baggage receipt location 200. It is noted that the cameras 20 may be appropriately added.

Fluoroscopic image data acquired by the inspection device 202 is displayed on the display device 30 or the output device 156 of the object recognition system 10. The observer of the airport checks the displayed fluoroscopic image data, and when determining that a hazardous material or doubtful item such as an edged tool is contained in the bag 300, specifies the bag 300 as a tracked target. The specifying method of specifying a tracked target includes specifying the bag 300 whose content appears in the fluoroscopic image data from the image data acquired by the camera 20A via the input device 155.

In this case, the object recognition system 10 sets the bag 300 specified as the tracked target as a specified subject. For example, the object recognition system sets the information that the bag 300 is the specified subject to an Id that identifies the bag 300. It is noted that the Id is mentioned later.

Moreover, the object recognition system 10 performs recognition processing to identify the bag 300 from the image data acquired by the cameras 20B and 20C. The object recognition system 10 then outputs the recognition result that is the result of the recognition processing to the output device 156 by using the user interface 101 or to the display device 30 by using the communication portion 102. At this time, when the identified bag 300 is the same as the specified subject, the object recognition system 10 is able to track the specified bag 300 and its owner easily by superimposing the recognition result onto the original image data.

It is noted that the object recognition system 10 may be directly aligned with the inspection device 202 without via the observer. For example, the estimation portion 108 of the object recognition system 10 estimates whether a target appears in fluoroscopic image data by using the object recognition model that sets a hazardous material and a doubtful item as a predetermined target. When the target appears, the estimation portion 108 sets the bag 300 corresponding to the fluoroscopic image data in which the target appears as the specified subject. In this case, it becomes possible to reduce the burden on the observers or the number of the observers. This enables cost reduction of the operation.

Thus, when the object recognition system 10 is applied to the baggage receipt location, the image data using the conveyor belt as the background, such as the image data acquired by the cameras 20A and 20B, can be collected in large amounts. The capture conditions for the image data acquired by the camera 20C, such as the background and angle of view, change in response to the receipt location where the camera 20C is installed and the installation position of the camera 20C at the receipt location. It is therefore difficult to collect equivalent image data in large amounts. Therefore, for example, when a new baggage receipt location is provided in an airport with the technique of the conventional machine learning, the images equivalent to ones acquired by the cameras 20A and 20B can be sufficiently collected but the images equivalent to ones acquired by the camera 20C may not be sufficiently collected. Even in such a situation, operations, functions, etc. of the object recognition system 10 able to accurately recognize a recognition target are explained below.

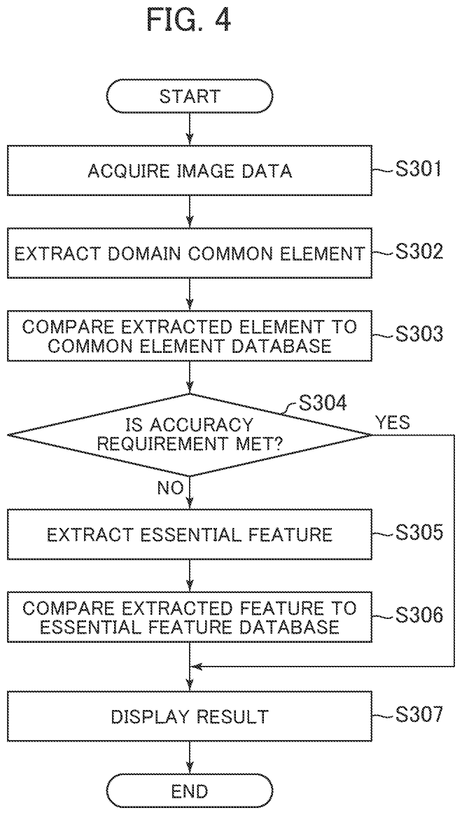

FIG. 4 is a flowchart to explain one example of recognition processing in which the object recognition system 10 detects a recognition target.

In the recognition processing, the image processing portion 103 of the object recognition system 10 first acquires image data acquired by the predetermined camera 20 (the newly installed camera 20C in the example of FIG. 3) via the communication portion 102 and extracts partial image data indicating the area where a predetermined subject (the bag 300 in the example of FIG. 3) appears from the image data as target image data (Step S301). It is noted that, when multiple predetermined subjects appear in the image data from which the target image data is extracted, the image processing portion 103 extracts multiple target image data respectively corresponding to the multiple subjects.

Then, the domain adaptation portion 104 performs domain adaption to the target image data to extract a domain common element from the target image data (Step S302). The database comparison portion 106 compares the domain common element extracted by the domain adaptation portion 104 to a common element database that is a database about domain common elements (Step S303).

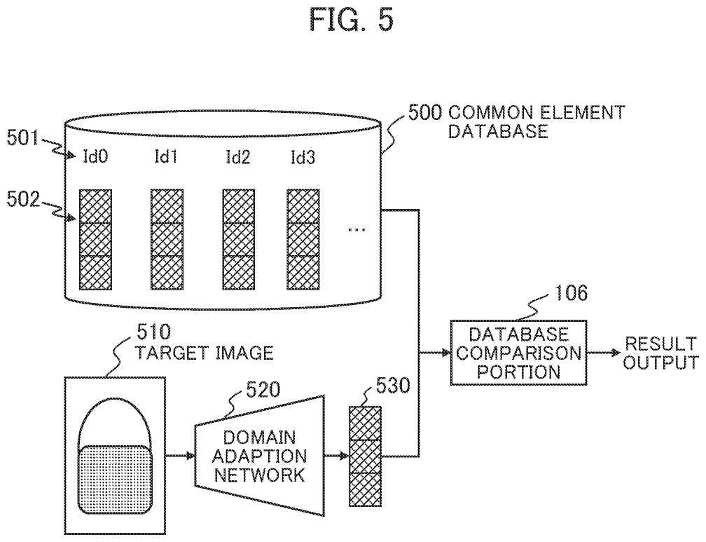

FIG. 5 explains processes of Steps S302 and S303 in more detail.

As illustrated in FIG. 5, in a common element database 500, a registration common element 502 that is the domain common element extracted from the image data indicating the bag 300 is stored for each Id 501 that identifies the bag 300 that is the predetermined subject. The image data from which the registration common element 502 is extracted is reference image data based on the image data acquired by at least one of the cameras 20A and 20B separate from the camera 20C which is the predetermined camera 20. It is noted that the method of registering the registration common element 502 to the common element database 500 is later mentioned using FIG. 12.

First, at Step S302, the domain adaptation portion 104 inputs target image data 510 into a domain adaptation network 520 that learns a function of extracting domain common elements to extract a domain common element 530 from the target image data 510. The domain adaptation portion 104 then inputs the domain common element 530 into the database comparison portion 106. The domain adaptation network 520 is a learned model that learns based on the image data acquired by the cameras 20A to 20C.

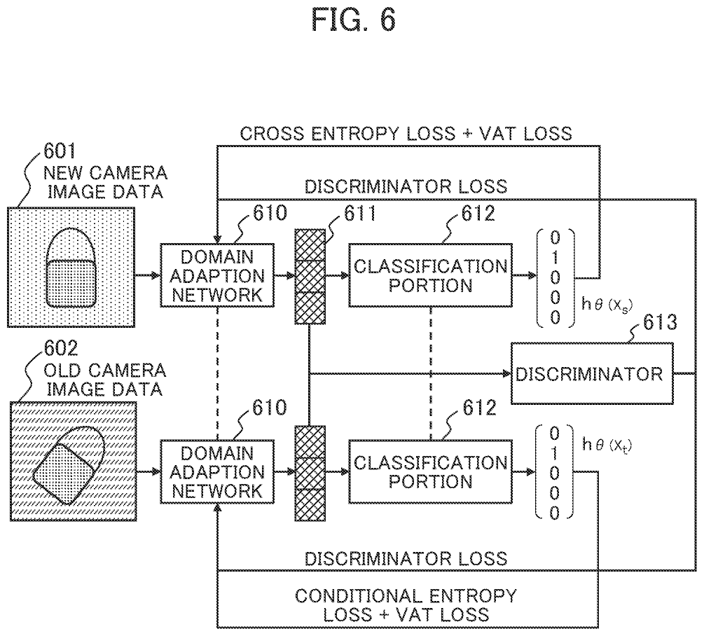

FIG. 6 explains an example of a learning method of the domain adaptation network 520. As illustrated in FIG. 6, when the domain adaptation network 520 learns, new camera image data 601 acquired by the same camera 20C as the camera that acquires target image data and old camera image data 602 acquired by the cameras 20A and 20B are used as teacher data. The new camera image data 601 may be small in amount. The old camera image data 602 is preferably large in amount, and may use, e.g., all available images.

In learning of a domain adaptation network 610, the new camera image data 601 and the old camera image data 602 are inputted to the domain adaptation network 610 before learning. A parameter of the domain adaptation network 610 is then adjusted by using three different loss functions computed based on a domain common element 611 outputted from the domain adaptation network 610. The learned domain adaptation network 610 is thus generated.

In the example of FIG. 6, the three loss functions include: a loss function based on cross entropy (Cross Entropy Loss); a loss function based on Hausdorffian distance corrected based on d-SNE (T-distributed Stochastic Neighbor Embedding) (VAT (Virtual Adversarial Training) Loss); and a loss function based on a discrimination result (Discriminator Loss). The loss function based on cross entropy and the loss function based on Hausdorffian distance corrected based on d-SNE are calculated based on a classification result h theta (Xs) in which the domain common element 611 acquired from each the new camera image data 601 and the old camera image data 602 is classified by a classifier 612. Moreover, the loss function based on the output of the discrimination result is calculated based on the discrimination result of discriminating the domain common element 611 acquired from each the new camera image data 601 and the old camera image data 602 in a discriminator 613.

Returning to the explanation of FIG. 5, at Step S303, the database comparison portion 106 compares the domain common element 530 to the registration common element 502 registered in the common element database 500 for each Id 501 to compute the similarity between the domain common element 530 and the registration common element 502 for each Id 501. The database comparison portion 106 generates information indicating the similarity for each Id 502 as a domain comparison result. The similarity is, for example, a classical metric distance such as Euclidean Distance.

Returning to the explanation FIG. 4, the database comparison portion 106 determines, based on the domain comparison result, whether a predetermined accuracy requirement about the matching rate between the domain common element 530 and the registration common element 502 most similar to the domain common element 530 is met (Step S304). In this embodiment, the accuracy requirement is that the similarity of the registration common element 502 most similar to the domain common element 530 is higher than a first threshold and the similarity of the registration common element 502 second most similar to the domain common element is lower than a second threshold. At this time, the similarity may be normalized to the value in the range of 0 to 1. The normalized similarity is higher nearer to 1. In this case, the first threshold is, e.g., 0.8, and the second threshold, e.g., 0.3, is smaller than the first threshold.

It is noted that the accuracy requirement is not limited to the above example, and for example, may be that the similarity of the registration common element 502 most similar to the domain common element 530 is higher than the first threshold.

When the accuracy requirement is not met, the essential feature extraction portion 105 performs essential feature extraction processing to the target image data to extract the essential feature from the target image data (Step S305). The database comparison portion 106 compares the essential feature extracted by the essential feature extraction portion 105 to an essential feature database that is a database about essential features (Step S306).

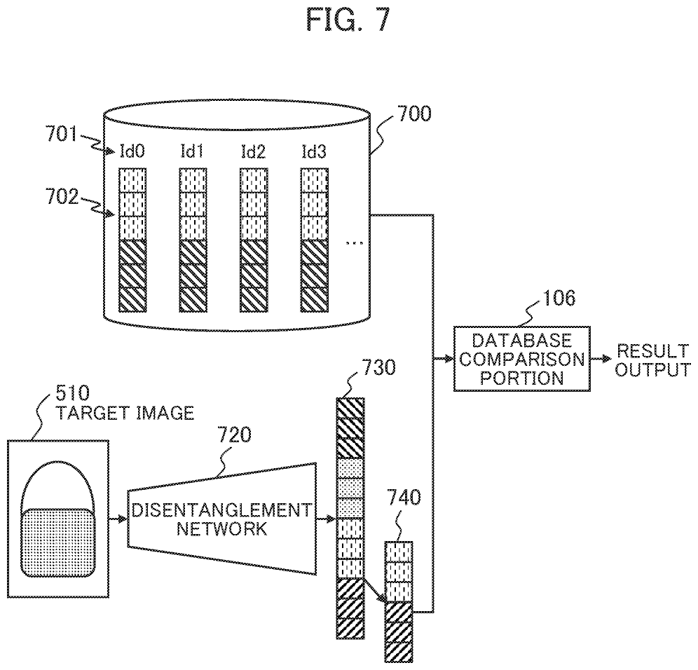

FIG. 7 explains processes of Steps S305 and S306 in more detail.

As illustrated in FIG. 7, an essential feature database 700 stores a registration feature 702 that is an essential feature extracted from the image data indicating the bag 300 for each Id 701. The Id 701 identifies the bag 300 that is the predetermined subject.

The Ids 701 may be common to the Ids 501 illustrated in FIG. 5. The image data from which the registration feature 702 is extracted is reference image data based on the image data acquired by at least one of the cameras 20A and 20B separate from the camera 20C that is the predetermined camera 20. It is noted that the registration method of the registration feature 702 into the essential feature database 700 is later mentioned using FIG. 12.

First, at Step S305, the essential feature extraction portion 105 inputs the target image data 510 into a disentanglement network 720 that learns a function of extracting a disentanglement feature to extract a disentanglement feature 730 from the target image data 510.

The disentanglement network 720 is, e.g., an auto encoder neural network. The auto encoder neural network is configured to have a disentanglement characteristic to disentangle a tangle of features respectively related to multiple elements related to a subject appearing in image data. The auto encoder neural network is able to output an element disentanglement feature including a feature for each element. The disentanglement network 720 (auto encoder neural network) is configured, e.g., by a combination of learned beta VAEs (valuable auto encoders).

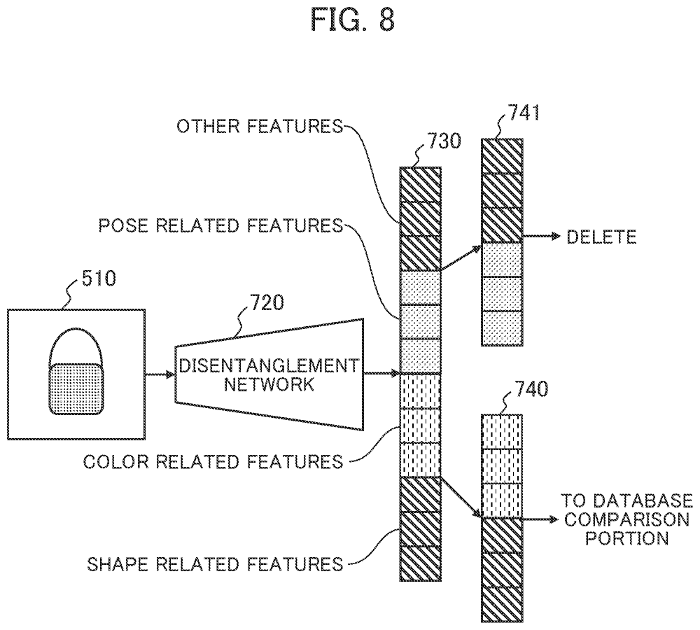

FIG. 8 illustrates an example of a disentanglement network configured by a combination of learned beta VAEs. The Beta VAE is known for having a disentanglement characteristic. For example, the Beta VAE is able to learn to disentangle features of the target image data 510 to a feature related to color and other features and output the disentangled features. In the present embodiment, the disentanglement network 720 configured by a combination of the learned beta VAEs as illustrated in FIG. 8 outputs, as the element disentanglement feature 730, a feature vector indicating a shape related feature related to a shape, a color related feature related to a color, a pose related feature related to a pose (rotation), and other features indicating other features related to other features.

The essential feature extraction portion 105 deletes the pose related feature changing with the capture condition of the camera 20C that acquires the target image data 510 and the other features as inessential features 741 depending on the capture condition of the camera 20C. Then, the essential feature extraction portion 105 inputs the shape related feature and the color related feature into the database comparison portion 106 as an essential feature 740 that is independent of the capture condition of the camera 20C and that is peculiar to the subject.

Returning to the explanation of FIG. 7, at Step S306, the database comparison portion 106 compares the essential feature 740 to the registration feature 702 registered in the essential feature database 700 for each Id 701 to compute the similarity between the essential feature 740 and the registration feature 702 for each Id 701. The database comparison portion 106 generates information indicating the similarity for each Id 702 as an essential comparison result. The similarity is a classic metric distance such as the Euclidean Distance.

Returning to the explanation of FIG. 4, based on the domain comparison result generated at Step S303 and the essential comparison result generated at Step S306, the database comparison portion 106 determines whether the recognition target appearing in the target image is the same as the specified subject (tracked target). The output portion that is the user interface 101 or the communication portion 102 outputs the determination result as a recognition result (Step S307) and the processing ends.

Specifically, when it is determined that the accuracy requirement is met at Step S304, the database comparison portion 106 identifies the bag 300 identified by the Id 501 corresponding to the registration common element 502 most similar to the domain common element 530 as the recognition target appearing in the target image data based on the domain comparison result. In contrast, when it is determined that the accuracy requirement is not met at Step S304, the database comparison portion 106 identifies the bag 300 identified by the Id 701 corresponding to the registration feature 702 most similar to the essential feature 740 as the recognition target that appears in the target image data based on the essential comparison result. The database comparison portion 106 determines whether the recognition target is the same as the set specified subject.

The method of outputting the determination result includes displaying the result on the output device 156 and outputting the result on the display device 30 by the communication portion 102. Moreover, when the recognition target is the same as the specified subject, the image processing portion 103 may highlight the specified subject on the original image data of the target image data in which the specified subject appears and output the highlighted image data as a determination result.

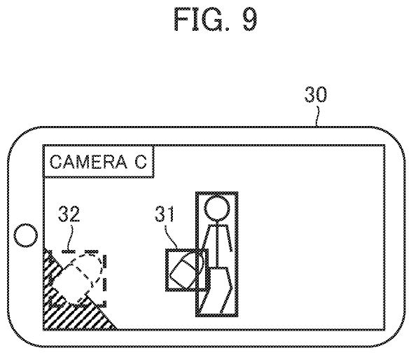

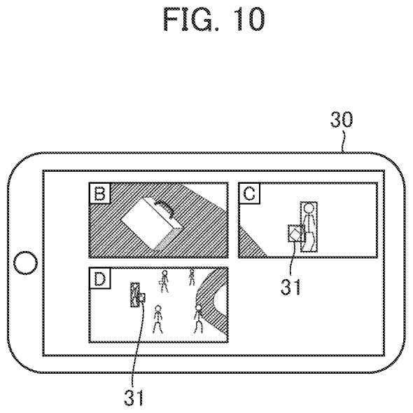

FIG. 9 and FIG. 10 illustrate display examples of determination results on the display device 30.

The example of FIG. 9 is a display example in which, onto the image data (acquired by the camera 20C) from which the target image data is generated, a rectangle 31 is superimposed to surround a part where the bag that is the specified subject appears and a part where the owner of the bag that is the specified subject appears to highlight the specified subject. In this case, the observer can easily identify the tracked target (specified subject). It is noted that the highlighting may surround a bag other than the specified subject by a rectangle 32 indicated by the broken line and the specified subject by the rectangle 31 indicated by the solid line.

The example of FIG. 10 is a display example in which multiple image data respectively acquired by the multiple cameras including the camera 20C are simultaneously displayed. In each image data, the rectangle 31 is superimposed to surround the part where the bag that is the specified subject appears.

It is noted that the display screens illustrated in FIG. 9 and the display screen illustrated in FIG. 10 may be switched in response to a manipulation of the user such as the observer. When a touch panel sensor is provided on the display device 30 and when the display screen illustrated in FIG. 9 is tapped, the display screen illustrated in FIG. 10 may be displayed. When any of the image data is tapped on the display screen illustrated in FIG. 10, the tapped image data may be displayed as illustrated in FIG. 9.

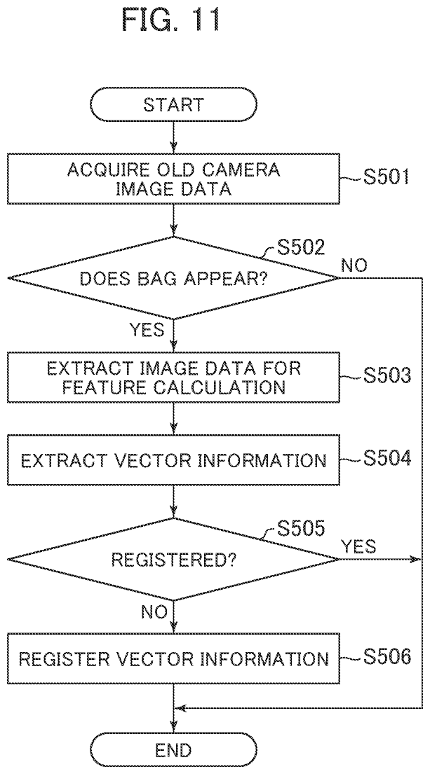

FIG. 11 is a flowchart for explaining building processing that builds a database.

In the building processing, the image processing portion 103 of the object recognition system 10 first acquires the old camera image data acquired by the cameras 20A and 20B via the communication portion 102 (Step S501).

The image processing portion 103 ascertains whether the bag that is the predetermined subject appears in the old camera image data (Step S502).

When the bag does not appear, the image processing portion 103 ends the processing. In contrast, when the bag appears, the image processing portion 103 extracts partial image data indicating the area where the bag appears as reference image data from the old camera image data to output the partial image data to the domain adaptation portion 104 and the essential feature extraction portion 105 (Step S503).

As well as at Step S302 of FIG. 4, the domain adaptation portion 104 performs domain adaptation to the reference image data to extract a domain common element that is vector information. Moreover, as well as at Step S305 of FIG. 4, the essential feature extraction portion 105 performs essential feature extraction processing to the reference image data to extract an essential feature which is vector information (Step S504).

The database comparison portion 106 determines whether the vector information extracted at Step S504 is already registered in the database (Step S505). In the present embodiment, the vector information used for the determination is an essential feature. In this case, when the registration feature in which the similarity to the essential feature (for example, metric distance) is a predetermined value or more is registered in the essential feature database, the vector information may be determined to be already registered in the database. It is noted that the information used for the determination may be a domain common element or both a domain common element and an essential feature.

When the vector information is registered, the database comparison portion 106 ends processing. In contrast, when the vector information is not registered, the database comparison portion 106 generates a new Id that does not overlap with the Id already registered in the database as an Id that identifies the reference subject appearing in the reference image data. The database comparison portion 106 corresponds the new Id to the domain common element and essential feature extracted at Step S504 and registers the new Id and the domain common element and essential feature into the database (Step S506). Then, the database comparison portion 106 ends the processing.

It is noted that all the extracted vector information may be registered into the database without the processing of Step S505.

In the present embodiment, the recognition target is explained as the bag, but the recognition target is not limited to bags. For example, the essential feature can be appropriately set in response to the recognition target. For example, when the recognition target is a person, the essential feature may use a feature related to a color of the clothes. Moreover, when the recognition target is an animal, the essential feature may use a feature related to a color of the body.

Moreover, according to the present embodiment explained above, the essential feature extraction portion 105 extracts, from the target image data based on the image data acquired by the camera 20C, a feature related to an element independent of the capture condition of the camera 20C as an essential feature among multiple features respectively related to multiple elements related to a subject appearing in the target image data. The database comparison portion 106 compares the essential feature to the registration feature that is the essential feature extracted from the reference image data based on the image data acquired by the cameras 20A and 20B separate from the camera 20C and identifies the subject based on the comparison result. Therefore, since the subject is identified based on the feature related to the element independent of the capture condition of the camera 20C, the recognition accuracy can be improved while reducing the time and cost for collection of teacher data.

Moreover, in the present embodiment, the essential feature is at least one of the feature about a color of the subject and the feature about a shape of the subject. Therefore, it becomes possible to extract an appropriate feature as the essential feature.

Moreover, in the present embodiment, the database comparison portion 106 identifies the reference subject corresponding to the registration feature having the highest similarity to the essential feature in the essential feature database to which the registration feature is registered for each reference subject appearing in the reference image data. Therefore, it becomes possible to identify the recognition target more appropriately.

Moreover, in the present embodiment, when the similarity in the registration feature having the highest similarity is higher than a predetermined value, the database comparison portion 106 identifies the reference target corresponding to the registration feature as the recognition target. Therefore, it becomes possible to identify the recognition target more appropriately.

Moreover, in the present embodiment, when the recognition target is the same as the specified subject, the image processing portion 103 performs image processing to the image data from which the target image data is generated to highlight the area in which the specified subject appears. The user interface 101 or the communication portion 102 outputs the image data to which image processing is performed. In this case, it becomes possible to make the user easily grasp the specified subject.

Moreover, in the present embodiment, the database comparison portion 106 registers the essential feature extracted from the reference image data into the essential feature database as the registration feature. Therefore, it becomes possible to perform the building and updating of the database in real-time, and it becomes possible to appropriately identify subjects when bags are recognized in an airport.

Moreover, in the present embodiment, the domain adaptation portion 104 extracts domain common elements of target image data. The database comparison portion 106 identifies a recognition target based on the comparison result of the essential features and based on the domain comparison result of comparing the domain common elements to the registration common elements that are domain common elements extracted from the reference image data. Therefore, it becomes possible to identify subjects more appropriately.

In this embodiment, when a predetermined accuracy requirement about the matching rate between the registration common element having the highest similarity to the domain common element and the domain common element is met, the database comparison portion 106 identifies the reference subject corresponding to the registration common element having the highest similarity as a subject. Then, the database comparison portion 106 identifies a subject based on the comparison result of the essential features when the accuracy requirement is not met. Therefore, it becomes possible to identify a subject more appropriately.

Moreover, in the present embodiment, the accuracy requirement is that the similarity of the registration common element having the highest similarity to the domain common element is higher than the first threshold and the similarity of the registration common element having the second highest similarity to the domain common element is lower than the second threshold smaller than the first threshold. Therefore, it becomes possible to identify a subject more appropriately.

Moreover, in the present embodiment, the database comparison portion 106 registers the domain common elements extracted from the reference image data into the common element database. Therefore, it becomes possible to perform the building and updating of the common element database in real-time. When bags are recognized in an airport, it becomes possible to appropriately identify a recognition target.

The above embodiments of the present disclosure are illustrated for explanation of the present disclosure, and is not intended to limit the range of the present disclosure to only the embodiments. The persons skilled in the art can carry out the present disclosure in other various aspects without deviating from the range of the present disclosure.

For example, unless particularly clearly indicated and basically clearly limited to a specific number, the number of the elements (including the number, values, amount, or range) is not limited to the specific number and may be more or less than the specific number. Moreover, the explanation of each function is one example. Multiple functions may be collected to one function or one function may be split into multiple functions. Moreover, any type of the existing learning model, e.g., a deep learning model, is used.

What is claimed is:

1. An object recognition system that identifies a subject appearing in target image data based on image data acquired by a predetermined capture device, comprising:
an extraction portion that extracts, from the target image data, a feature related to an element independent of a capture condition of the capture device as an essential feature among a plurality of features respectively related to a plurality of elements related to the subject appearing in the target image data; and
a comparison portion that compares the essential feature to a registration feature that is the essential feature extracted from reference image data based on image data acquired by a separate capture device from the capture device to identify the subject.

2. The object recognition system according to claim 1 wherein
the essential feature is at least any one of a feature related to a color of the subject and a feature related to a shape of the subject.

3. The object recognition system according to claim 1 wherein
the comparison portion identifies, as the subject, a reference subject corresponding to a registration feature having a highest similarity to the essential feature in an essential feature database in which the registration feature is registered for each reference subject appearing in the reference image data.

4. The object recognition system according to claim 3 wherein
when the similarity in the registration feature having the highest similarity is higher than a predetermined value, the comparison portion identifies a reference subject corresponding to the registration feature as the subject.

5. The object recognition system according to claim 3 further comprising:
an image processing portion that performs image processing to image data from which the target image data is generated to highlight an area in which the specified subject appears when the subject is identical to a specified subject that is the reference subject previously specified; and
an output portion that outputs image data to which the image processing is performed.

6. The object recognition system according to claim 3 wherein
the extraction portion extracts the essential feature from the reference image data for each reference image data, and
the comparison portion registers an essential feature extracted from the reference image data into the essential feature database as the registration feature.

7. The object recognition system according to claim 1 further comprising:
a domain adaptation portion that inputs the target image data into a domain adaptation network trained based on image data respectively acquired by the capture device and the separate capture device to extract a domain common element indicating a common feature under capture conditions of the capture device and the separate capture device from the target image data,
wherein
the comparison portion identifies the subject based on the comparison result and based on a domain comparison result of comparing the domain common element to a registration common element that is the domain common element extracted from the reference image data.

8. The object recognition system according to claim 7 wherein
when a predetermined accuracy requirement related to a matching rate between a registration common element having a highest similarity to the domain common element in a common element database into which the registration common element is registered for each reference subject appearing in the reference image data and the domain common element is met, the comparison portion identifies the reference subject corresponding to the registration common element having the highest similarity as the subject, and when the accuracy requirement is not met, the comparison portion identifies the subject based on the comparison result.

9. The object recognition system according to claim 8 wherein
the accuracy requirement is that a similarity of a registration common element having a highest similarity to the domain common element is higher than a first threshold and a similarity of a registration common element having a second highest similarity to the domain common element is lower than a second threshold.

10. The object recognition system according to claim 8 wherein
the domain adaptation portion extracts, for each reference image data, the domain common element from the reference image data, and
the comparison portion registers the domain common element extracted from the reference image data into the common element database as the registration common element.

11. An object recognition method using an object recognition system that identifies a subject appearing in target image data based on image data acquired by a predetermined capture device, comprising:
extracting, from the target image data, a feature related to an element independent of a capture condition of the capture device as an essential feature among a plurality of features respectively related to multiple elements related to the subject appearing in the target image data; and
comparing the essential feature to a registration feature that is the essential feature extracted from reference image data based on image data acquired by a separate capture device from the capture device to identify the subject based on the comparison result.
